(19) United States
(12) Patent Application Publication
(10) Pub. No.: US 2013/0179508 A1
(43) Pub. Date: Jul. 11, 2013

(54) DATA SEND/RECEPTION DEVICE

(71) Applicants: Kabushiki Kaisha Toshiba, Tokyo (JP); Chisae Suzuki, Tokyo (JP)

(72) Inventors: Tsukasa Matoba, Kanagawa (JP); Kiyoshi Toshimitsu, Tokyo (JP); Masayuki Kadono, Tokyo (JP); Yoshiyuki Matsubara, Tokyo (JP); Kenichi Koga, Tokyo (JP); Chisae Suzuki, (US)

(73) Assignee: Kabushiki Kaisha Toshiba, Tokyo (JP)

(21) Appl. No.: 13/621,440

(22) Filed: Sep. 17, 2012

(30) Foreign Application Priority Data
Jan. 10, 2012 (JP) 2012-002365

(51) Int. Cl. G06F 15/16; H04W 8/00

(52) U.S. Cl. 709/204

(57) ABSTRACT

According to one embodiment, a data send/reception device includes a storage unit configured to store a profile. It further includes a PROFILE control unit configured to control send of a profile to other data send/reception device and reception of a profile from the other data send/reception device by mutually sending and receiving the profiles to exchange the profiles. It further includes a wireless control unit configured to control wireless communication with the other data send/reception device.

### CROSS-REFERENCE TO RELATED APPLICATIONS

This application is based upon and claims the benefit of priority from Japanese Patent Application No. 2012-002365, filed on Jan. 10, 2012; the entire contents of which are incorporated herein by reference.

### FIELD

Embodiments described herein relate generally to a data send/reception device.

### BACKGROUND

Conventionally, data is sent/received between portable information terminals by use of infrared rays or the like. In recent years, there is a method in which a terminal such as a digital camera having no Internet connection function or call function is approached to the party's terminal to send/receive data between the terminals.

### BRIEF DESCRIPTION OF THE DRAWINGS

FIG. 1 is a diagram illustrating an exemplary structure of hardware of a data send/reception device;

FIG. 2 is a diagram illustrating an exemplary structure of function blocks of the data send/reception device;

FIG. 3 is a flowchart illustrating PROFILE exchange processing; and

FIGS. 4A to 4J are diagrams illustrating display contents of the data send/reception devices in each stage of the PROFILE exchange processing.

### DETAILED DESCRIPTION

In general, according to one embodiment, a data send/reception device includes a storage unit that stores a profile as owner information. It further includes a PROFILE control unit that controls send of the profile to other data send/reception device and reception of a profile from the other data send/reception device by mutually sending and receiving the profiles to exchange the profiles. It further includes a wireless control unit that controls wireless communication with the other data send/reception device. When first receiving a profile, the PROFILE control unit starts up until it starts receiving the profile from the other data send/reception device.

Exemplary embodiments of a data send/reception device will be explained below in detail with reference to the accompanying drawings. The present invention is not limited to the following embodiments.

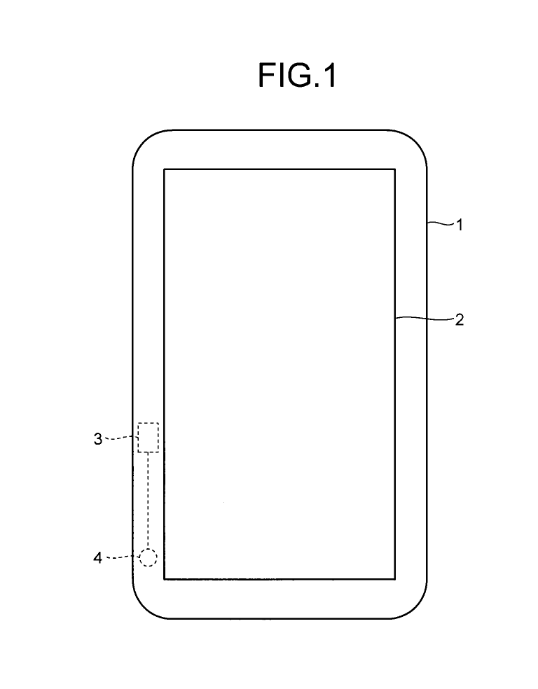

FIG. 1 is a diagram illustrating an exemplary structure of hardware of a data send/reception device. The data send/reception device 1 includes a touch panel unit 2 that displays images and receives touch operations. It further includes a transfer-jet unit 3 and a coupler 4 therein in order to send/receive data to/from other data send/reception device 1. With the transfer-jet unit 3 and the coupler 4, the couplers 4 are made closer to each other in the devices with the same structure (the transfer-jet unit 3 and the coupler 4) to make wireless connection, thereby easily sending/receiving data. The structure is exemplary, and a structure in which a display unit and an operation unit are separated may be used without using the touch panel unit 2. The data send/reception method may employ a method other than transfer-jet.

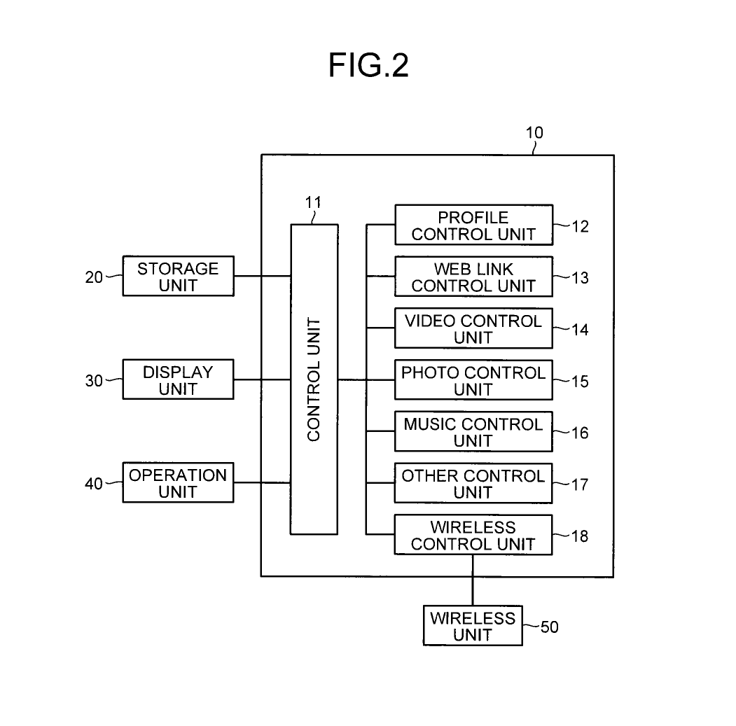

FIG. 2 is a diagram illustrating an exemplary structure of function blocks in the data send/reception device 1. The data send/reception device 1 includes a CPU (Central Processing Unit) unit 10, a storage unit 20, a display unit 30, an operation unit 40 and a wireless unit 50. The CPU unit 10 includes a control unit 11, a PROFILE control unit 12, a WEBLINK control unit 13, a VIDEO control unit 14, a PHOTO control unit 15, a MUSIC control unit 16, an OTHER control unit 17, and a wireless control unit 18.

The control unit 11 controls send/reception of data in all the data types in association with other structure. The PROFILE control unit 12 controls data send/reception processing when the data type is PROFILE. The WEBLINK control unit 13 controls data send/reception processing when the data type is WEBLINK. The VIDEO control unit 14 controls data send/reception processing when the data type is VIDEO (animation). The PHOTO control unit 15 controls data send/reception processing when the data type is PHOTO (still image). The MUSIC control unit 16 controls data send/reception processing when the data type is MUSIC (music). The OTHER control unit 17 controls data send/reception processing when the data type is PDF other than the above data, for example. The wireless control unit 18 performs connection processing or authentication processing with the data send/reception party via the wireless unit 50. Each of the PROFILE control unit 12 to the OTHER control unit 17 is a data control unit that controls the data send/reception processing. Each data control unit is exemplary, and the data send/reception device 1 is assumed to be provided with a corresponding data control unit depending on a type of data to be handled.

The storage unit 20 stores each item of the above data such as profile (PROFILE) data as owner information described later. The storage unit 20 may be SSD (Solid State Drive), for example, but is not limited thereto.

The display unit 30 displays the standby screen or data thumbnails before performing data send/reception. It corresponds to the touch panel unit 2 in FIG. 1.

The operation unit 40 receives selection of data to be sent from a user. It corresponds to the touch panel unit 2 in FIG. 1.

The wireless unit 50 actually sends/receives data to/from a device as a communication party under control of the wireless control unit 18. It corresponds to the transfer-jet unit 3 and the coupler 4 in FIG. 1.

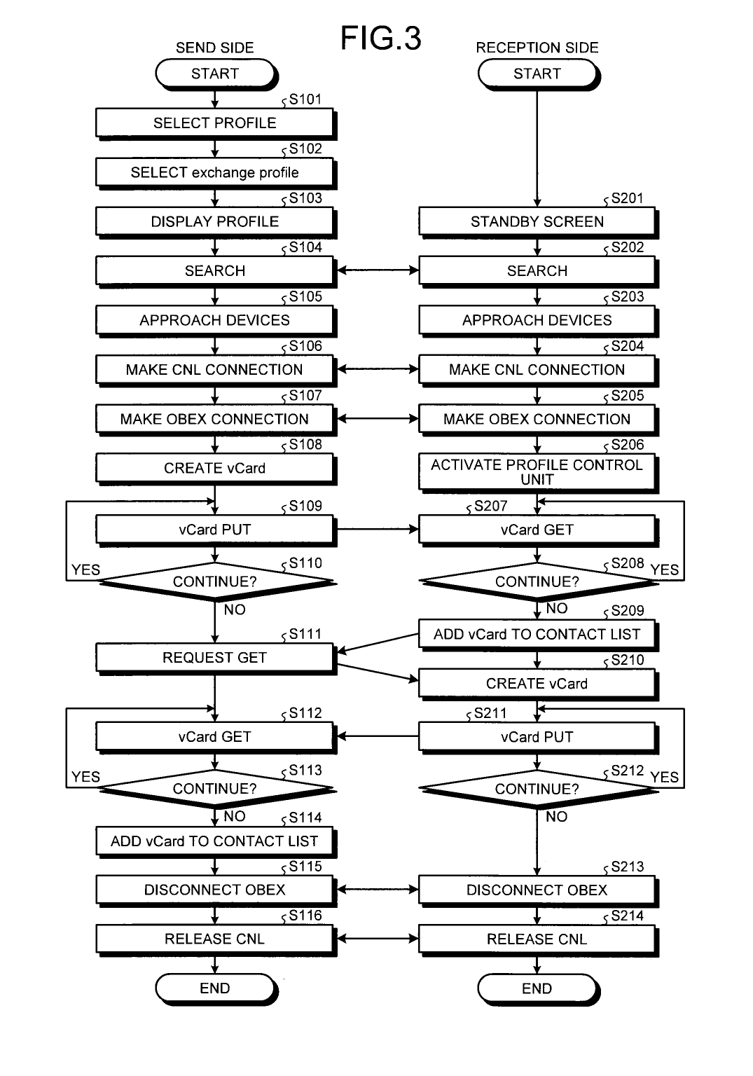

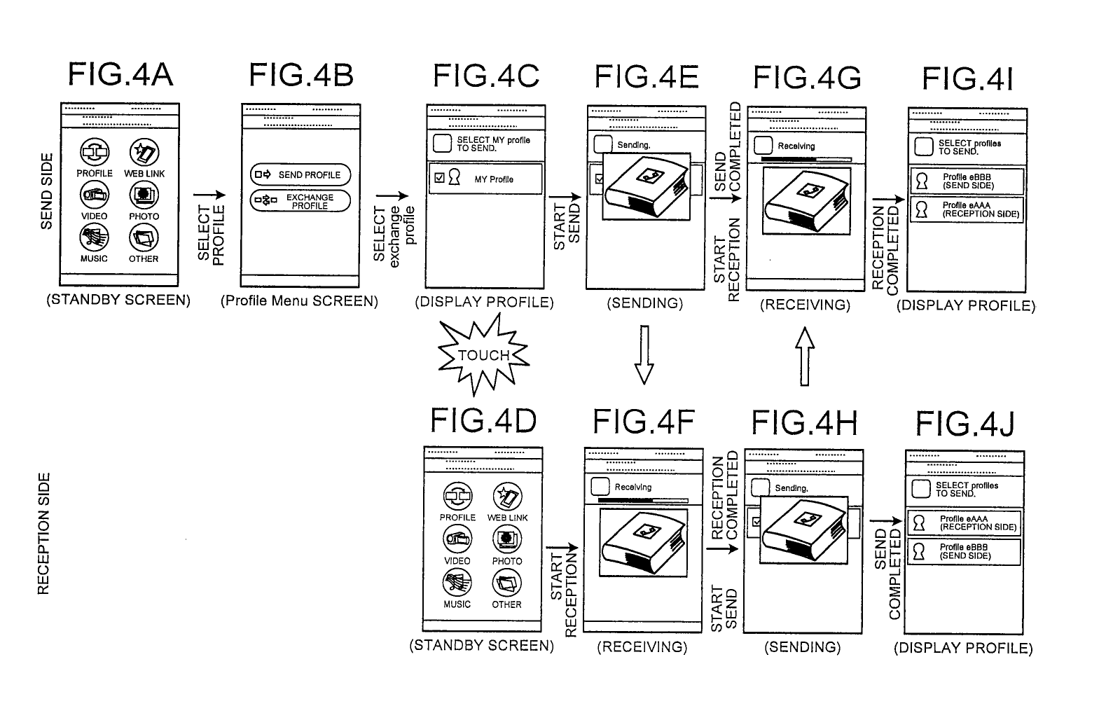

Subsequently, the PROFILE exchange processing performed by the data send/reception device 1 will be described. There will be described herein a case in which two data send/reception devices 1 are used and the PROFILE exchange processing are started with the operation of one data send/reception device 1. FIG. 3 is a flowchart illustrating the PROFILE exchange processing. FIGS. 4A to 4J are diagrams illustrating display contents of the data send/reception devices in each stage of the PROFILE exchange processing.

At first, the control unit 11 in the data send/reception device 1 on the send side controls the display unit 30 to display the standby screen indicating a data type (FIG. 4A). The data type indicated on the standby screen corresponds to each data control unit in the CPU unit 10. The user selects a data type for send on the standby screen. PROFILE is selected here (step S101).

The control unit 11 receives the user operations from the operation unit 40, and activates the PROFILE control unit 12. The PROFILE control unit 12 displays a Profile Menu screen on the display unit 30 via the control unit 11 (FIG. 4B). The user selects exchange profile on the Profile Menu screen by way of example (step S102).

The PROFILE control unit 12 receives the user operations from the operation unit 40 via the control unit 11, extracts PROFILE as its owner information from the storage unit 20, and displays PROFILE on the display unit 30 via the control unit 11 (step S103) (FIG. 4C). PROFILE contains information such as user's name, address, phone number and photos.

While displaying PROFILE, the wireless control unit 18 in the data send/reception device 1 on the send side uses the wireless unit 50 to deliver radios, and searches whether the device that delivers radios or other data send/reception device 1 (the data send/reception device 1 on the reception side herein) that mutually sends/receives PROFILE to exchange PROFILE is present in a close range (step S104).

On the other hand, in the data send/reception device 1 on the reception side, a search is similarly made as to whether the device that delivers radios or other data send/reception device 1 (the data send/reception device 1 on the send side herein) is present in a close range (step S202) from the state of the standby screen (FIG. 4D) (step S201).

Then, the data send/reception devices 1 on the send side and on the reception side are approached each other (step S105, S203). In transfer-jet, the approach is called touch (FIGS. 4C and D), and specifically, both the couplers 4 illustrated in FIG. 1 are approached.

The wireless control unit 18 in the data send/reception device 1 on the send side sends a CNL (Connection Layer) connection request from the wireless unit 50 to the data send/reception device 1 on the reception side. The wireless control unit 18 in the data send/reception device 1 on the reception side having received the CNL connection request sends CNLaccept from the wireless unit 50 to the data send/reception device 1 on the send side. Then, the data send/reception device 1 on the send side receives CNLaccept. With the processing, the data send/reception devices 1 on the send side and on the reception side complete the CNL connection (steps S106, S204).

Then, in the data send/reception devices 1 on the send side and on the reception side, the wireless control unit 18 makes OBEX (OBject EXchange) connection (steps S107, S205). Specifically, the wireless control unit 18 in the data send/reception device 1 on the send side sends an OBEX connection request from the wireless unit 50 to the data send/reception device 1 on the reception side. The wireless control unit 18 in the data send/reception device 1 on the reception side having received the OBEX connection request sends OBEXaccept from the wireless unit 50 to the data send/reception device 1 on the send side. Then, the data send/reception device 1 on the send side receives OBEXaccept. With the processing, the data send/reception devices 1 on the send side and on the reception side complete the OBEX connection.

After the OBEX connection (steps S107, S205), the PROFILE control unit 12 in the data send/reception device 1 on the send side converts its owner PROFILE into a vCard form, that is, creates vCard (step S108). At this time, the wireless control unit 18 in the data send/reception device 1 on the send side sends information on size of the created vCard, MIME TYPE and the like via the wireless unit 50 to the data send/reception device 1 on the reception side. When the PROFILE control unit 12 in the data send/reception device 1 on the reception side is not active on the timing of reception of the information, the control unit 11 can activate the PROFILE control unit 12 (step S206).

Then, the wireless control unit 18 in the data send/reception device 1 on the send side transfers (PUT) vCard via the wireless unit 50 (step S109). When data to be sent is present (step S110: Yes), the wireless control unit 18 continues to transfer (PUT) vCard via the wireless unit 50 (step S109) (FIG. 4E). The wireless control unit 18 in the data send/reception device 1 on the reception side receives (GET) vCard via the wireless unit 50 (step S207). Then, when data to be received is present (step S208: Yes), the wireless control unit 18 continues to receive (GET) vCard via the wireless unit 50 (step S207) (FIG. 4F).

When the wireless control unit 18 in the data send/reception device 1 on the reception side finishes receiving (GET) vCard via the wireless unit 50 (step S208: No), the PROFILE control unit 12 activated after wireless connection adds the received vCard information to a contact list stored in the storage unit 20 via the control unit 11 (step S209). At this time, the wireless control unit 18 in the data send/reception device 1 on the reception side notifies storage completion to the data send/reception device 1 on the send side.

The PROFILE control unit 12 in the data send/reception device 1 on the send side having finished sending (PUT) vCard (step S110: No) and having been notified of the storage completion requests the data send/reception device 1 on the reception side to send PROFILE (vCard), that is, requests GET from the data send/reception device 1 on the send side to the data send/reception device 1 on the reception side (step S111).

The PROFILE control unit 12 in the data send/reception device 1 on the reception side having received the GET request converts PROFILE as its owner information into the vCard form, that is, creates vCard (step S210). At this time, the wireless control unit 18 in the data send/reception device 1 on the reception side sends information on size of the created vCard to the data send/reception device 1 on the send side via the wireless unit 50.

Then, the wireless control unit 18 in the data send/reception device 1 on the reception side transfers (PUT) vCard via the wireless unit 50 (step S211). When data to be sent is present (step S212: Yes), the wireless control unit 18 continues to transfer (PUT) PROFILE via the wireless unit 50 (step S211) (FIG. 4H). The wireless control unit 18 in the data send/reception device 1 on the send side receives (GET) PROFILE via the wireless unit 50 (step S112). When data to be received is present (step S113: Yes), the wireless control unit 18 continues to receive (GET) PROFILE via the wireless unit 50 (step S112) (FIG. 4G).

When the wireless control unit 18 in the data send/reception device 1 on the send side finishes receiving (GET) vCard via the wireless unit 50 (step S113: No), the PROFILE control unit 12 adds the received vCard information to a contact list stored in the storage unit 20 via the control unit 11 (step S114).

After the addition of vCard to the contact list in the data send/reception device 1 on the send side (step S114) and after the completion of send of vCard in the data send/reception device 1 on the reception side (step S212: No), in the data send/reception devices 1 on the send side and on the reception side, the wireless control unit 18 disconnects the OBEX connection (steps S115, S213), and releases the CNL connection (steps S116, S214). At this time, the displays on the display units 30 in the data send/reception devices 1 on the send side and on the reception side are as illustrated in FIGS. 41 and 4J, respectively. The data send/reception devices 1 on the send side and on the reception side display each other's PROFILE.

Then, the data send/reception devices 1 on the send side and on the reception side terminate the PROFILE exchange processing.

In this way, even when the PROFILE control unit 12 in the data send/reception device 1 on the reception side is not active, the data send/reception device 1 on the send side can operate thereby to start exchanging PROFILE. PROFILE is directly sent and received between the data send/reception devices 1, and thus a connection environment to the Internet or the like is not needed.

The PROFILE exchange has been described, and PROFILE may be sent from the data send/reception device 1 on the send side to the data send/reception device 1 on the reception side. Also in this case, PROFILE can be sent with the operation of the data send/reception device 1 on the send side.

As described above, according to the present embodiment, when PROFILE is exchanged between two data send/reception devices 1, the data send/reception device 1 that first sends PROFILE is operated to send PROFILE to the other party, and then the party data send/reception device receiving PROFILE sends its PROFILE to the data send/reception device 1 having sent PROFILE earlier without a user operation. Thereby, with the operation of the data send/reception device 1 that first sends PROFILE, PROFILE can be exchanged between the two data send/reception devices 1, thereby enhancing user convenience.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A data send/reception device that mutually sends and receives a profile as owner information to exchange the profile, comprising:
a storage unit configured to store the profile;
a profile control unit configured to control send of the profile to other data send/reception device to exchange the profile therewith, and reception of a profile from the other data send/reception device; and
a wireless control unit configured to control wireless communication with the other data send/reception device,
wherein when first receiving a profile, the profile control unit starts up until it starts receiving the profile from the other data send/reception device.

2. The data send/reception device according to claim 1, wherein when first sending a profile, after the wireless control unit makes wireless connection with the other data send/reception device, the started-up profile control unit sends its own profile extracted from the storage unit to the other data send/reception device, and then receives a profile from the other data send/reception device, and
when first receiving a profile, the profile control unit starts up until it starts receiving the profile from the other data send/reception device, thereby to receive the profile from the other data send/reception device, and then sends its own profile extracted from the storage unit to the other data send/reception device.

3. The data send/reception device according to claim 1, comprising:
a display unit configured to display the profile,
wherein the profile control unit displays the sent profile and the received profile on the display unit.

4. The data send/reception device according to claim 2, comprising:
a display unit configured to display the profile,
wherein the profile control unit displays the sent profile and the received profile on the display unit.

5. The data send/reception device according to claim 1, wherein the profile is data in a vCard form.

6. The data send/reception device according to claim 2, wherein the profile is data in a vCard form.

7. The data send/reception device according to claim 3, wherein the profile is data in a vCard form.

8. The data send/reception device according to claim 4, wherein the profile is data in a vCard form.

9. The data send/reception device according to claim 1, wherein the wireless control unit makes wireless communication via transfer-jet.

10. The data send/reception device according to claim 2, wherein the wireless control unit makes wireless communication via transfer-jet.

11. The data send/reception device according to claim 3, wherein the wireless control unit makes wireless communication via transfer-jet.

12. The data send/reception device according to claim 4, wherein the wireless control unit makes wireless communication via transfer-jet.

13. The data send/reception device according to claim 5, wherein the wireless control unit makes wireless communication via transfer-jet.

14. The data send/reception device according to claim 6, wherein the wireless control unit makes wireless communication via transfer-jet.

15. The data send/reception device according to claim 7, wherein the wireless control unit makes wireless communication via transfer-jet.

16. The data send/reception device according to claim 8, wherein the wireless control unit makes wireless communication via transfer-jet.
